(19) United States
(12) Patent Application Publication
(10) Pub. No.: US 2025/0225913 A1
(43) Pub. Date: Jul. 10, 2025

(54) LIGHT BOARDS AND DISPLAY PANELS

(71) Applicant: WUHAN CHINA STAR OPTOELECTRONICS TECHNOLOGY CO., LTD., Wuhan, Hubei (CN)

(72) Inventors: Wenhao LI, Wuhan, Hubei (CN); Lei ZHU, Wuhan, Hubei (CN)

(73) Assignee: WUHAN CHINA STAR OPTOELECTRONICS TECHNOLOGY CO., LTD., Wuhan, Hubei (CN)

(21) Appl. No.: 18/293,385

(22) PCT Filed: Jan. 16, 2024
(86) PCT No.: PCT/CN2024/072445

§ 371 Date: Jan. 30, 2024

(30) Foreign Application Priority Data
Jan. 4, 2024 (CN) 202410017829.6

(51) Int. Cl. G09G 3/32

(52) U.S. Cl. CPC G09G 3/32; G09G 2300/0426; G09G 2300/043; G09G 2310/0218; G09G 2310/08; G09G 2320/064

(57) ABSTRACT

Light boards and display panels are provided. The light board includes multiple light-emitting units. The light board has multiple brightness subareas. A fixed number of light-emitting units are provided in each brightness subarea. In two adjacent brightness subareas in a first direction, the light-emitting units in one brightness subarea and the light-emitting units in the other brightness subarea do not light up simultaneously. In two adjacent brightness subareas in a second direction, the light-emitting units in one brightness subarea and the light-emitting units in the other brightness subarea do not light up simultaneously.

### TECHNICAL FIELD

The present disclosure relates to the field of display technologies, and in particular, to light boards and display panels.

### BACKGROUND

Mini light-emitting diode (Mini LED) display technology has entered a stage of accelerated development in the past two years and is widely used in high dynamic range (HDR) image sensors and full-screen display applications. Compared with organic light-emitting diode (OLED) display screens, Mini LED display screens show better advantages in costs, contrast, brightness, and appearance.

At present, a light board of a Mini LED display panel generally use a pulse width modulation (PWM) driving mode, but in the PWM driving mode, due to excessive instantaneous brightness, a phosphor layer of Mini LEDs on the light board is prone to rule failure (such as stripe failure) depending on a scanning state, seriously affecting visual experience and causing the display quality of Mini LED display panel to decline, and the problems needs to be solved urgently.

### SUMMARY

The present disclosure provides light boards and display panels, which can effectively solve the existing problems of excessive instantaneous brightness, prone to rule failure, and poor optical effects in existing light boards.

In a first aspect, the present disclosure provides light boards. The light board has a plurality of brightness subareas, each of the brightness subareas is provide with a fixed number of light-emitting units. The plurality of brightness subareas include multiple brightness subareas arranged sequentially in a first direction and multiple brightness subareas arranged sequentially in a second direction, and the first direction and the second direction intersect. In two adjacent brightness subareas in the first direction, the light-emitting units in one brightness subarea and the light-emitting units in the other brightness subarea do not light up simultaneously. In two adjacent brightness subareas in the second direction, the light-emitting units in one brightness subarea and the light-emitting units in the other brightness subarea do not light up simultaneously.

In a second aspect, the present disclosure provides display panels. The display panel includes the light board described in any one of the above.

### DESCRIPTION OF DRAWINGS

In order to more clearly illustrate the technical solutions in the embodiments of the present disclosure, the drawings needed to be used in the description of the embodiments will be briefly introduced below. Obviously, the drawings in the following description are only some embodiments of the present disclosure. For those skilled in the art, other drawings may also be obtained based on these drawings without exerting creative efforts.

FIG. 1 is a schematic plan view of a light board provided in Embodiment 1 of the present disclosure.

FIG. 2 is a graph of the brightness and distance of a single brightness subarea in an active state in any direction.

FIG. 3a is a schematic plan view showing that light-emitting units in each brightness subarea in a first brightness subarea group corresponding to a first scanning electrode provided in Embodiment 1 of the present disclosure are in an active state.

FIG. 3b is a schematic plan view showing that light-emitting units in each brightness subarea in a second brightness subarea group corresponding to a second scanning electrode provided in Embodiment 1 of the present disclosure are in an active state.

FIG. 4 is a timing diagram of signals applied on the first scanning electrode and the second scanning electrode provided in Embodiment 1 of the present disclosure.

FIG. 5 is a schematic diagram of a film structure of a scanning line provided by an embodiment of the present disclosure.

FIG. 6a is a schematic plan view showing that light-emitting units in each brightness subarea in a first brightness subarea group corresponding to a first scanning electrode provided in Embodiment 2 of the present disclosure are in an active state.

FIG. 6b is a schematic plan view showing that light-emitting units in each brightness subarea in a second brightness subarea group corresponding to a second scanning electrode provided in Embodiment 2 of the present disclosure are in an active state.

FIG. 6c is a schematic plan view showing that light-emitting units in each brightness subarea in a third brightness subarea group corresponding to a third scanning electrode provided in Embodiment 2 of the present disclosure are in an active state.

FIG. 6d is a schematic plan view showing that light-emitting units in each brightness subarea in a fourth brightness subarea group corresponding to a fourth scanning electrode provided in Embodiment 2 of the present disclosure are in an active state.

FIG. 6e is a schematic plan view showing that light-emitting units in each brightness subarea in a fifth brightness subarea group corresponding to a fifth scanning electrode provided in Embodiment 2 of the present disclosure are in an active state.

FIG. 6f is a schematic plan view showing that light-emitting units in each brightness subarea in a sixth brightness subarea group corresponding to a sixth scanning electrode provided in Embodiment 2 of the present disclosure are in an active state.

FIG. 6g is a schematic plan view showing that light-emitting units in each brightness subarea in a seventh brightness subarea group corresponding to a seventh scanning electrode provided in Embodiment 2 of the present disclosure are in an active state.

FIG. 6h is a schematic plan view showing that light-emitting units in each brightness subarea in an eighth brightness subarea group corresponding to an eighth scanning electrode provided in Embodiment 2 of the present disclosure are in an active state.

FIG. 7 is a timing diagram of signals applied on the first scanning electrode to the eighth scanning electrode provided in Embodiment 2 of the present disclosure.

FIG. 8a is a schematic plan view of scanning electrodes and first portions of scanning lines provided in Embodiment 2 of the present disclosure.

FIG. 8b is a schematic plan view of second portions of the scanning lines provided in Embodiment 2 of the present disclosure.

FIG. 9a is a schematic diagram of light distribution of a light board in related art.

FIG. 9b is a schematic diagram of light distribution of a light board provided by the present disclosure.

FIG. 10a is a schematic plan view showing that light-emitting units in each brightness subarea in a 1st brightness subarea group in a 1 st brightness subarea block corresponding to a first scanning electrode provided in Embodiment 3 of the present disclosure are in an active state.

FIG. 10b is a schematic plan view showing that light-emitting units in each brightness subarea in a 1st brightness subarea group in a 2nd brightness subarea block corresponding to a second scanning electrode provided in Embodiment 3 of the present disclosure are in an active state.

FIG. 10c is a schematic plan view showing that light-emitting units in each brightness subarea in a 2nd brightness subarea group in a 1st brightness subarea block corresponding to a third scanning electrode provided in Embodiment 3 of the present disclosure are in an active state.

FIG. 10d is a schematic plan view showing that light-emitting units in each brightness subarea in a 2nd brightness subarea group in a 2nd brightness subarea block corresponding to a fourth scanning electrode provided in Embodiment 3 of the present disclosure are in an active state.

FIG. 11 is a timing diagram of signals applied on the first scanning electrode to the fourth scanning electrode provided in Embodiment 3 of the present disclosure.

FIG. 12a is a schematic plan view showing that light-emitting units in each brightness subarea in a first brightness subarea group corresponding to a first scanning electrode of a light board provided in Embodiment 4 of the present disclosure are in an active state.

FIG. 12b is a schematic plan view showing that light-emitting units in each brightness subarea in a second brightness subarea group corresponding to a second scanning electrode provided of a light board provided in Embodiment 4 of the present disclosure are in an active state.

FIG. 12c is a schematic plan view showing that light-emitting units in each brightness subarea in a third brightness subarea group corresponding to a third scanning electrode of a light board provided in Embodiment 4 of the present disclosure are in an active state.

### EXPLANATION OF REFERENCE SYMBOLS

light board 10; brightness subarea 20; light-emitting unit 30; scanning electrode 40; first scanning electrode 41; second scanning electrode 42; third scanning electrode 43; fourth scanning electrode 44; fifth scanning electrode 45; sixth scanning electrode 46; seventh scanning electrode 47; eighth scanning electrode 48; scanning line 50; first portion 51; second portion 52; brightness subarea block 60; brightness subarea group 70; first brightness subarea group 71; second brightness subarea group 72; third brightness subarea group 73; fourth brightness subarea group 74; fifth brightness subarea group 75; sixth brightness subarea group 76; seventh brightness subarea group 77; eighth brightness subarea group 78; 1^{st} brightness subarea block M1; 2^{nd} brightness subarea block M2; 1^{st} brightness subarea group M11 in the 1^{st} brightness subarea block; 1^{st} brightness subarea group M21 in the 2^{nd} brightness subarea block; 2^{nd} brightness subarea group M12 in the 1^{st} brightness subarea block; 2^{nd} brightness subarea group M22 in the 2^{nd} brightness subarea block; first direction X; second direction Y.

### EMBODIMENTS OF THE INVENTION

In a first aspect, the present disclosure provides light boards. The light board has a plurality of brightness subareas, each of the brightness subareas is provide with a fixed number of light-emitting units. The plurality of brightness subareas include multiple brightness subareas arranged sequentially in a first direction and multiple brightness subareas arranged sequentially in a second direction, and the first direction and the second direction intersect. In two adjacent brightness subareas in the first direction, the light-emitting units in one brightness subarea and the light-emitting units in the other brightness subarea do not light up simultaneously. In two adjacent brightness subareas in the second direction, the light-emitting units in one brightness subarea and the light-emitting units in the other brightness subarea do not light up simultaneously.

Optionally, the light board includes a plurality of scanning electrodes electrically connected to the light-emitting units and configured to control active states of the light-emitting units; in the two adjacent brightness subareas in the first direction, one of the scanning electrodes connected to the light-emitting units in one of the two adjacent brightness subareas is different from another one of the scanning electrodes connected to the light-emitting units the other one of the two adjacent brightness subareas; in the two adjacent brightness subareas in the second direction, one of the scanning electrodes connected to the light-emitting units in one of the two adjacent brightness subareas is different from another one of the scanning electrodes connected to the light-emitting units the other one of the two adjacent brightness subareas; and timings of driving signals of the scanning electrodes corresponding to the two adjacent brightness subareas in the first direction are different, and timings of driving signals of the scanning electrodes corresponding to the two adjacent brightness subareas in the second direction are different.

Optionally, a number of the scanning electrodes is a, a number of the brightness subareas is b, and each of the scanning electrodes is electrically connected to the light-emitting units in b/a ones of the brightness subareas, where b≥a≥2 and b/a is an integer.

Optionally, the light board includes m brightness subarea blocks, where m≥1 and m is an integer; each of the brightness subarea blocks includes n brightness subarea groups, where n≥2 and n is an integer; and each of the brightness subarea groups includes at least one brightness subarea; and the light board includes m×n scanning electrodes, and each of the scanning electrodes is electrically connected to the light-emitting units in all of the brightness subareas in one of the brightness subarea groups.

Optionally, each of the brightness subarea blocks includes a plurality rows of the brightness subareas and a plurality columns of the brightness subareas; and in each of the brightness subarea blocks, each of the scanning electrodes corresponding to one of the brightness subarea groups is electrically connected to the light-emitting units in at least one brightness subarea in each row of the brightness subareas.

Optionally, in each of the brightness subarea blocks, each of the scanning electrodes corresponding to one of the brightness subarea groups is electrically connected to the light-emitting units in at least one brightness subarea in each column of the brightness subareas.

Optionally, m=1 and n=2, one of the scanning electrodes corresponding to one of the brightness subarea groups is electrically connected to the light-emitting units in the brightness subareas in odd rows and odd columns and the light-emitting units in the brightness subareas in even rows and columns, and one of the scanning electrodes corresponding to the other one of the brightness subarea groups is electrically connected to the light-emitting units in the brightness subareas in even rows and odd columns and the light-emitting units in the brightness subareas in odd rows and even columns.

Optionally, m=1 and n is an integer greater than 2, each of the scanning electrodes corresponding to one of the brightness subarea groups is electrically connected to the light-emitting units in one brightness subarea in each row of the brightness subareas, and each of the scanning electrodes corresponding to one of the brightness subarea groups is electrically connected to the light-emitting units in one brightness subarea in each column of the brightness subareas.

Optionally, m is an integer greater than 1, one phase period includes n cycles, during an n-th cycle, each of the brightness subareas in an n-th brightness subarea group in a 1^{st} brightness subarea block to each of the brightness subarea in an n-th brightness subarea group in an m-th brightness subarea block are lit in sequence.

Optionally, m=2 and n=2, the light board includes the 1^{st} brightness subarea block and a 2^{nd} brightness subarea block arranged axially symmetrically; the brightness subareas in odd rows and odd columns and the brightness subarea blocks in even rows and even columns in the 1^{st} brightness subarea block consist a 1^{st} brightness subarea group in the 1^{st} brightness subarea block, and the brightness subareas in even rows and odd columns and the brightness subarea blocks in odd rows and even columns in the 1^{st} brightness subarea block consist a 2^{nd} brightness subarea group in the 1^{st} brightness subarea block; the brightness subareas in odd rows and odd columns and the brightness subarea blocks in even rows and even columns in the 2^{nd} brightness subarea block consist a 1^{st} brightness subarea group in the 2^{nd} brightness subarea block, and the brightness subareas in even rows and odd columns and the brightness subarea blocks in odd rows and even columns in the 2^{nd} brightness subarea block consist a 2^{nd} brightness subarea group in the 2^{nd} brightness subarea block; one phase period includes 2 cycles; during a 1^{st} cycle, the light-emitting units in each of the brightness subareas in the 1^{st} brightness subarea group in the 1^{st} brightness subarea block and the light-emitting units in each of the brightness subareas in the 1^{st} brightness subarea group in the 2^{nd} brightness subarea block are lit in sequence; and then during a 2^{nd} cycle, the light-emitting units in each of the brightness subareas in the 2^{nd} brightness subarea group in the 1^{st} brightness subarea block and the light-emitting units in each of the brightness subareas in the 2^{nd} brightness subarea group in the 2^{nd} brightness subarea block are lit in sequence.

Optionally, each of the brightness subarea blocks includes three brightness subarea groups, each of the brightness subarea groups includes three brightness subareas, and nine brightness subarea blocks corresponding to the three brightness subarea groups define a nine-square grid structure, two of the brightness subareas in each of the brightness subarea groups are arranged in the same row, or two of the brightness subareas in each of the brightness subarea groups are arranged in the same column.

Optionally, the light board further includes a plurality of scanning lines, the scanning electrodes are connected to the light-emitting units in the brightness subareas through the scanning lines, each of the plurality of scanning lines includes a first portion and a second portion, the first portion is arranged in the same layer as the scanning electrodes, and the second portion is arranged in a different layer from the scanning lines.

In a second aspect, the present disclosure provides a display panel, which includes the light board described in any one of the above.

The present disclosure provides light boards and display panels. The light board includes the plurality of light-emitting units. The light board has the plurality of brightness subareas. A fixed number of light-emitting units are provided in each brightness subarea. The plurality of brightness subareas include multiple brightness subareas arranged sequentially in a first direction and multiple brightness subareas arranged sequentially in a second direction, and the first direction and the second direction intersect. In two adjacent brightness subareas in the first direction, the light-emitting units in one brightness subarea and the light-emitting units in the other brightness subarea do not light up simultaneously. In two adjacent brightness subareas in the second direction, the light-emitting units in one brightness subarea and the light-emitting units in the other brightness subarea do not light up simultaneously. In the light board and display panel provided by the present disclosure, in the two adjacent brightness subareas in the first direction, the light-emitting units in one brightness subarea and the light-emitting units in the other brightness subarea do not light up at the same time; and in the two adjacent brightness subareas in the second direction, the light-emitting unit in one brightness subarea and the light-emitting units in the other brightness subarea do not light up at the same time. Therefore, during actual operation of the light board, staggered lighting of the light-emitting units in the plurality of brightness subareas may be achieved. On the one hand, it may improve the problem of instantaneous local energy concentration of the light board in the PWM driving mode, inhibiting the possibility of short-term failure. On the other hand, it may effectively reduce the probability of rule failure in a long-term lighting state of the light board. Furthermore, the optical effect of the light board and the optical effect of the display panel applying the light board are improved, and the life of the light board and the life of the display panel applying the light board are extended.

The technical solutions in the embodiments of the present disclosure will be clearly and completely described below with reference to the accompanying drawings in the embodiments of the present disclosure. Obviously, the described embodiments are only some of the embodiments of the present disclosure, rather than all embodiments. Based on the embodiments in the present disclosure, all other embodiments obtained by those skilled in the art without making creative efforts fall within the protection scope of the present disclosure. In addition, it should be understood that the specific embodiments described here are only used to illustrate and explain the application, and are not intended to limit the application. In the present disclosure, unless otherwise specified, the orientational terms such as “on” and “below” usually refer to the upper and lower positions of the device in actual use or working conditions, specifically the orientations in the drawings, and the terms “inside” and “outside” refer to the outline of the device.

The following disclosure provides many different embodiments or examples for implementing the various structures of the present disclosure. To simplify the disclosure of the present disclosure, the components and arrangements of specific examples are described below. Of course, they are merely examples and are not intended to limit the application. Furthermore, the present disclosure may repeat reference numbers and/or reference letters in different examples, such repetition being for the purposes of simplicity and clarity and does not by itself indicate a relationship between the various embodiments and/or arrangements discussed. In addition, the present disclosure provides examples of various specific processes and materials, but one of ordinary skill in the art may recognize the application of other processes and/or the use of other materials. Detailed descriptions are provided below. It should be noted that the order of description of the following embodiments is not intended to limit the preferred order of the embodiments.

### Embodiment 1

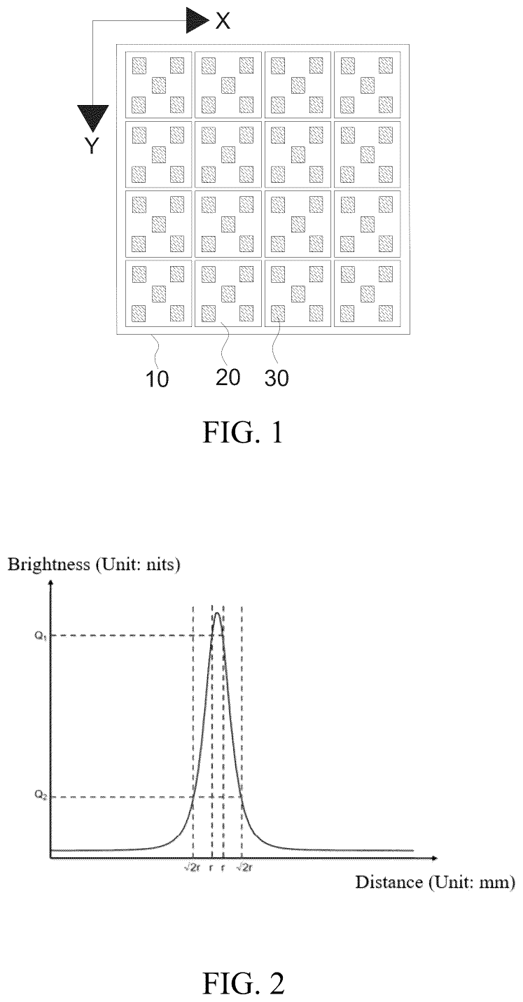

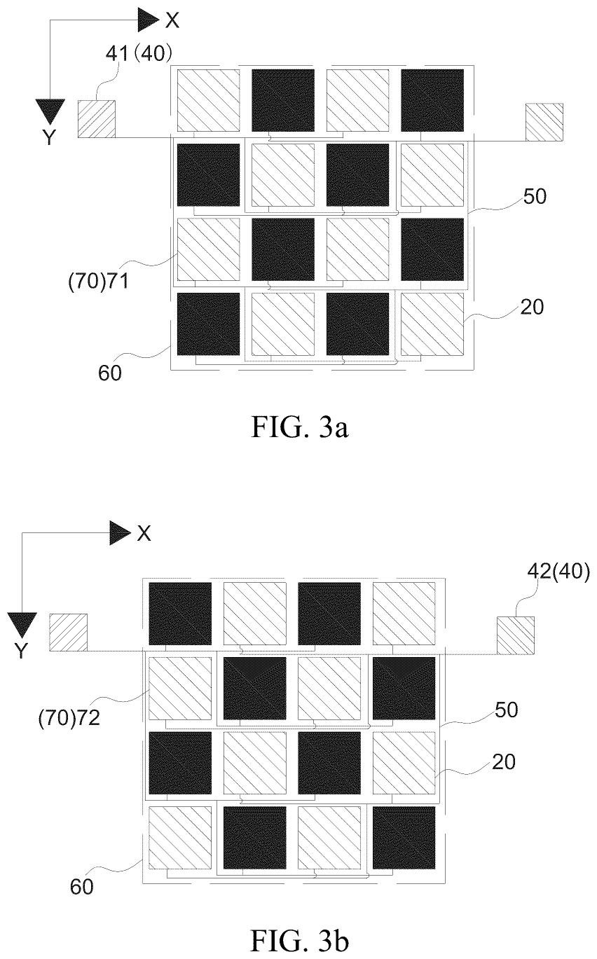

FIG. 1 is a schematic plan view of a light board provided in Embodiment 1 of the present disclosure, FIG. 2 is a graph of the brightness and distance of a single brightness subarea in an active state in any direction, FIG. 3a is a schematic plan view showing that light-emitting units in each brightness subarea in a first brightness subarea group corresponding to a first scanning electrode provided in Embodiment 1 of the present disclosure are in an active state, and FIG. 3b is a schematic plan view showing that light-emitting units in each brightness subarea in a second brightness subarea group corresponding to a second scanning electrode provided in Embodiment 1 of the present disclosure are in an active state. As illustrated in FIG. 1, FIG. 2, FIG. 3a, and FIG. 3b, in a first aspect, Embodiment 1 of the present disclosure provides a light board 10. The light board 10 includes a plurality of light-emitting units 30, and the light board 10 has a plurality of brightness subareas 20. Each brightness subarea 20 is provided with a fixed number of the light-emitting units 30. The plurality of brightness subareas 20 include multiple brightness subareas 20 arranged sequentially in a first direction X and multiple brightness subareas 20 arranged sequentially in a second direction Y, and the first direction X and the second direction Y intersect. In two adjacent brightness subareas 20 in the first direction X, the light-emitting units 30 in one brightness subarea 20 and the light-emitting units 30 in the other brightness subarea 20 do not light up simultaneously. In two adjacent brightness subareas 20 in the second direction Y, the light-emitting units 30 in one brightness subarea 20 and the light-emitting units 30 in the other brightness subarea 20 do not light up simultaneously.

It is found in the research that in the PWM driving mode, when the light-emitting units 30 in two adjacent brightness subareas 20 in the first direction X or the second direction Y light up at the same time, an instantaneous excessive brightness may occur. It is further found that a relationship between the brightness and distance of the light-emitting unit 30 (such as Mini LED) in each brightness subarea 20 in any direction is shown in FIG. 2, where r represents a distance between one light-emitting unit 30 in a central area in the brightness subarea 20 and an edge of the brightness subarea 20. That is, assuming that a shape of the brightness subarea 20 is square, the brightness of a midpoint of one side of the square is Q1, and the brightness of an endpoint of the side of the square is Q2, then Q2 is far less than Q1.

In the light board 10 provided by the embodiment of the present disclosure, in the two adjacent brightness subareas 20 in the first direction, the light-emitting units 30 in one brightness subarea 20 and the light-emitting units 30 in the other brightness subarea 20 do not light up at the same time; and in the two adjacent brightness subareas 20 in the second direction Y, the light-emitting unit 30 in one brightness subarea 20 and the light-emitting units 30 in the other brightness subarea 20 do not light up at the same time. Therefore, during actual operation of the light board 10, staggered lighting of the light-emitting units 30 in the plurality of brightness subareas 20 may be achieved. On the one hand, it may improve the problem of instantaneous local energy concentration of the light board 10 in the PWM driving mode, inhibiting the possibility of short-term failure. On the other hand, it may effectively reduce the probability of rule failure in a long-term lighting state of the light board 10. Furthermore, the optical effect of the light board 10 and the optical effect of a display panel applying the light board 10 are improved, and the life of the light board 10 and the life of the display panel applying the light board 10 are extended.

Continuing to refer to FIG. 1, in some embodiments of the present disclosure, multiple light-emitting units 30 are provided in each brightness subarea 20. Specifically, by making each of the brightness subareas 20 include multiple light-emitting units 30, a number of the brightness subareas 20 may be reduced, thereby reducing the driving difficulty of the light board 10. When the brightness subareas 20 and driver chips are arranged in one-to-one correspondence, a number of the driver chips may be effectively reduced; and when all the brightness subareas 20 are arranged corresponding to one driver chip, manufacturing costs of the light board 10 may be reduced. Of course, the present disclosure does not limit a number of the light-emitting units 30 in each brightness subarea 20. In other embodiments of the present disclosure, only one light-emitting unit 30 may be provided in each brightness subarea 20.

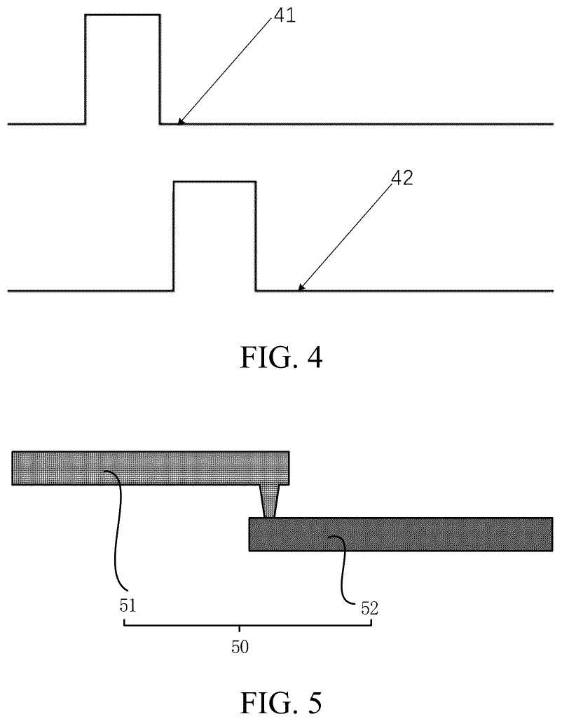

FIG. 4 is a timing diagram of signals applied on the first scanning electrode and the second scanning electrode provided in Embodiment 1 of the present disclosure. Continuing to refer to FIG. 3a, FIG. 3b, and FIG. 4, in some embodiments of the present disclosure, the light board 10 includes a plurality of scanning electrodes 40, and the scanning electrodes 40 are electrically connected to the light-emitting units 30 for controlling the active state of the light-emitting units 30. In the two adjacent brightness subareas 20 in the first direction X, one scanning electrode 40 connected to the light-emitting units 30 in one brightness subarea 20 is different from another scanning electrode 40 connected to the light-emitting units 30 in the other brightness subarea 20. In the two adjacent brightness subareas 20 in the second direction Y, one scanning electrode 40 connected to the light-emitting units 30 in one brightness subarea 20 is different from another scanning electrode 40 connected to the light-emitting units 30 in the other brightness subarea 20. And the timings of driving signals of the scanning electrodes 40 corresponding to the two adjacent brightness subareas 20 in the first direction X are different, and the timings of driving signals of the scanning electrodes 40 corresponding to the two adjacent brightness subareas 20 in the second direction Y are different.

In the light board 10 provided by the present disclosure, the plurality of scanning electrodes 40 of the light board 10 are electrically connected to the light-emitting units 30 in the brightness subareas 20 and can send the driving signals to the light-emitting units 30 to control the active state of the light-emitting units 30. Since the timings of the driving signals of the scanning electrodes 40 corresponding to the two adjacent brightness subareas 20 in the first direction X are different, in the two adjacent brightness subareas 20 in the first direction X, when one scanning electrode 40 connected to the light-emitting units 30 in one brightness subarea 20 is different from another scanning electrode 40 connected to the light-emitting units 30 in the other brightness subarea 20, the light-emitting units 30 in one brightness subarea 20 and the light-emitting units 30 in the other brightness subarea 20 do not light up simultaneously. Similarly, since the timings of the driving signals of the scanning electrodes 40 corresponding to the two adjacent brightness subareas 20 in the second direction Y are different, in the two adjacent brightness subareas 20 in the second direction Y, when one scanning electrode 40 connected to the light-emitting units 30 in one brightness subarea 20 is different from another scanning electrode 40 connected to the light-emitting units 30 in the other brightness subarea 20, the light-emitting units 30 in one brightness subarea 20 and the light-emitting units 30 in the other brightness subarea 20 do not light up simultaneously. Furthermore, the light board 10 provided by the present disclosure can enable staggered lighting of the light-emitting units 30 in two adjacent brightness subareas 20 in the first direction X or the second direction Y under the control of the driving signals of the plurality of scanning electrodes 40, thereby improving the optical effects of the light board 10 and the display panel applying the light board 10, and extending the life of the light board 10 and the display panel applying the light board 10.

In some embodiments of the present disclosure, the number of the scanning electrodes 40 is a, and the number of the brightness subareas 20 is b, and each scanning electrode 40 is electrically connected to the light-emitting units 30 in b/a brightness subareas 20, where b≥a≥2, and b/a is an integer.

In the light board 10 provided by the present disclosure, since each of the scanning electrodes 40 is electrically connected to the light-emitting units 30 in b/a brightness subareas 20, a number of the brightness subareas 20 corresponding to each scanning electrode 40 is the same, which may balance driving loads of the scanning electrodes 40, reduce the design difficulty of scanning lines 50 corresponding to the scanning electrodes 40, improve the stability of the light board 10, and extend the service life of the light board 10. Optionally, each of the scanning electrodes 40 is electrically connected to the light-emitting units 30 in at least two brightness subareas 20, that is, b/a≥2.

In some embodiments of the present disclosure, the light board 10 includes m brightness subarea blocks 60, where m≥1 and m is an integer. Each of the brightness subarea blocks 60 includes n brightness subarea groups 70, where n≥2 and n is an integer. Each of the brightness subarea groups 70 includes at least one brightness subarea 20. The light board 10 includes m×n scanning electrodes 40, and each scanning electrode 40 is electrically connected to the light-emitting units 30 in all brightness subareas 20 in one brightness subarea group 70. The two adjacent brightness subareas 20 in the first direction X respectively belong to two different brightness subarea groups 70, and the two adjacent brightness subareas 20 in the second direction Y respectively belong to two different brightness subarea groups 70. One of the first direction X and the second direction Y is a row direction, and the other of the first direction X and the second direction Y is a column direction.

In the light board 10 provided by the present disclosure, when an area of the light board 10 is small, or the number of the brightness subareas 20 is small, or the wiring difficulty of the scanning lines 50 corresponding to the scanning electrodes 40 is low, the light board 10 may not be divided into blocks, at this time, the light board 10 only includes one brightness subarea block 60, that is, m=1. When the area of the light board 10 is large, or the number of the brightness subareas 20 is large, or the wiring difficulty of the scanning lines 50 corresponding to the scanning electrodes 40 is high, by dividing the light board 10 into blocks, the process difficulty may be effectively reduced and the production yield may be improved; at this time, the light board 10 may include a plurality of brightness subarea blocks 60, that is, m is an integer greater than 1. Therefore, the light board 10 may be divided into a plurality of repeatedly arranged brightness subarea blocks 60 by dividing the light board 10 equally. Of course, in other embodiments of the present disclosure, an area and a shape of each brightness subarea block 60 and a layout of the brightness subareas 20 therein may be different.

Continuing to take the light board 10 including a plurality of brightness subarea blocks 60 arranged repeatedly as an example, as mentioned above, the plurality of brightness subarea blocks 60 are provided to reduce process difficulty and improve production yield, so that the scanning lines 50 in each brightness subarea block 60 are independent of the scanning lines 50 in other brightness subarea blocks 60. Correspondingly, the scanning electrodes 40 corresponding to each of the brightness subarea blocks 60 should also be different. On this basis, since each scanning electrode 40 is electrically connected to the light-emitting units 30 in all brightness subareas 20 in one brightness subarea group 70, it is assumed that the number of the brightness subarea blocks 60 is m, and each of the brightness subarea blocks 60 includes n brightness subarea groups 70 respectively corresponding to independent scanning electrodes 40, the number of the scanning electrodes 40 of the light board 10 is m×n.

In addition, in order to enable the light board 10 to meet the requirements that in the two adjacent brightness subareas 20 in the first direction X, one scanning electrode 40 connected to the light-emitting units 30 in one brightness subarea 20 is different from another scanning electrode 40 connected to the light-emitting units 30 in the other brightness subarea 20, and in the two adjacent brightness subareas 20 in the second direction Y, one scanning electrode 40 connected to the light-emitting units 30 in one brightness subarea 20 is different from another scanning electrode 40 connected to the light-emitting units 30 in the other brightness subarea 20, the two adjacent brightness subareas 20 in the first direction X should respectively belong to two different brightness subarea groups 70, and the two adjacent brightness subareas 20 in the second direction Y should respectively belong to two different brightness subarea groups 70.

In some embodiments of the present disclosure, each of the brightness subarea blocks 60 includes a plurality rows of brightness subareas 20 and a plurality columns of brightness subareas 20. In each of the brightness subarea blocks 60, the scanning electrode 40 corresponding to each brightness subarea group 70 is electrically connected to the light-emitting units 30 in at least one brightness subarea 20 in each row of the brightness subareas 20.

In the light board 10 provided by the present disclosure, in each of the brightness subarea blocks 60, the scanning electrode 40 corresponding to each brightness subarea group 70 is electrically connected to the light-emitting units 30 in at least one brightness subarea 20 in each row of the brightness subareas 20, so the scanning lines 50 corresponding to each of the scanning electrodes 40 may be referenced more clearly in the wiring design as much as possible, thereby reducing the design difficulty.

In some embodiments of the present disclosure, the scanning electrode 40 corresponding to each brightness subarea group 70 is electrically connected to the light-emitting units 30 in at least one brightness subarea 20 in each column of the brightness subareas 20.

In the light board 10 provided by the present disclosure, the scanning electrode 40 corresponding to each brightness subarea group 70 is electrically connected to the light-emitting units 30 in at least one brightness subarea 20 in each column of the brightness subareas 20, so the scanning lines 50 corresponding to each of the scanning electrodes 40 may be referenced more clearly in the wiring design as much as possible, thereby reducing the design difficulty.

Referring to FIG. 3a and FIG. 3b, in some embodiments of the present disclosure, m=1, n=2. That is, the light board 10 only includes one brightness subarea block 60, and the brightness subarea block 60 includes two brightness subarea groups 70, which are respectively a first brightness subarea group 71 and a second brightness subarea group 72. The light board 10 includes two scanning electrodes 40, which are respectively a first scanning electrode 41 and a second scanning electrode 42. The scanning electrode 40 corresponding to each brightness subarea group 70 in the brightness subarea block 60 is electrically connected to the light-emitting units 30 in multiple brightness subareas 20 in each row of the brightness subarea 20. The scanning electrode 40 corresponding to each brightness subarea group 70 in the brightness subarea block 60 is electrically connected to the light-emitting units 30 in multiple brightness subareas 20 in each column of the brightness subareas 20.

Continuing to refer to FIG. 3a and FIG. 3b, the scanning electrode 40 (that is, the first scanning electrode 41) corresponding to one of the brightness subarea groups 70 (that is, the first brightness subarea group 71) is electrically connected to the light-emitting units 30 in the brightness subareas 20 in odd rows and odd columns and the light-emitting units 30 in the brightness subareas 20 in even rows and columns, and the scanning electrode 40 (that is, the second scanning electrode 42) corresponding to another brightness subarea group 70 (that is, the second brightness subarea group 72) is electrically connected to the light-emitting units 30 in the brightness subareas 20 in even rows and odd columns and the light-emitting units 30 in the brightness subareas 20 in odd rows and even columns.

Continuing to refer to FIG. 3a and FIG. 3b, the brightness subarea block 60 includes 4 rows and 4 columns i.e. a total of 16 brightness subareas 20. The first brightness subarea group 71 includes the brightness subareas 20 in Row 1 Column 1, Row 1 Column 3, Row 2 Column 2, Row 2 Column 4, Row 3 Column 1, Row 3 Column 3, Row 4 Column 2, and Row 4 Column 4. The first scanning electrode 41 is electrically connected to the light-emitting units 30 in the eight brightness subareas 20 in the first brightness subarea group 71. The second brightness subarea group 72 includes the brightness subarea 20 in Row 1 Column 2, Row 1 Column 4, Row 2 Column 1, Row 2 Column 3, Row 3 Column 2, Row 3 Column 4, Row 4 Column 1, and Row 4 Column 3. The second scanning electrode 42 is electrically connected to the light-emitting units 30 in the eight brightness subareas 20 in the second brightness subarea group 72.

Continuing to refer to FIG. 4, during one phase period, the light-emitting units 30 in all brightness subareas 20 on the light board 10 are lit once. One phase period includes one cycle, and during the cycle, the driving signals of the first scanning electrode 41 and the second scanning electrode 42 are sequentially transmitted to the light-emitting units 30 in each brightness subarea 20 in the corresponding first brightness subarea group 71 and the light-emitting units 30 in each brightness subarea 20 in the corresponding second brightness subarea group 72. The timing of the drive signal of the second scanning electrode 42 comes after the timing of the driving signal of the first scanning electrode 41, that is, the first scanning electrode 41 and the second scanning electrode 42 are scanned sequentially. This scanning method can enable that the light-emitting units 30 in each brightness subarea 20 in the second brightness subarea group 72 turn on after the light-emitting units 30 in each brightness subarea 20 in the first brightness subarea group 71 turn on, thereby achieving that in the two adjacent brightness subareas 20 in the first direction X, the light-emitting units 30 in one brightness subarea 20 and the light-emitting units 30 in the other brightness subarea 20 do not light up at the same time, and in the two adjacent brightness subareas 20 in the second direction Y, the light-emitting units 30 in one brightness subarea 20 and the light-emitting units 30 in the other brightness subarea 20 do not light up at the same time.

FIG. 5 is a schematic diagram of a film structure of a scanning line provided by an embodiment of the present disclosure. Referring to FIG. 3a, FIG. 3b, and FIG. 5, in some embodiments of the present disclosure, the light board 10 also includes a plurality of scanning lines 50. The scanning electrodes 40 are connected to the light-emitting units 30 in the brightness subareas 20 through the scanning lines 50. Each of the plurality of scanning lines 50 includes a first portion 51 and a second portion 52. The first portion 51 is arranged in the same layer as the scanning electrode 40, and the second portion 52 is arranged in a different layer from the scanning line 50.

In the light board 10 provided by the present disclosure, when the scanning line 50 corresponding to one scanning electrode 40 and the scanning line 50 corresponding to another scanning electrode 40 cross in the first direction X or the second direction Y, the two scanning lines 50 with different extension directions may interfere, increasing the difficulty of wiring design. In the present disclosure, each of the plurality of scanning lines 50 includes the first portion 51 and the second portion 52, the first portion 51 is arranged in the same layer as the scanning electrode 40, and the second portion 52 is arranged in a different layer from the scanning line 50, which may reduce a number of film layers as much as possible while improving the interference problem between two scanning lines 50 with different extension directions through the double-layer design, thereby reducing the wiring difficulty of the scanning lines 50 on the light board 10.

In a second aspect, the embodiment of the present disclosure further provides a display panel, which includes the light board 10 described in any one of the above. Optionally, the display panel includes the light board 10 and a liquid crystal cell. The liquid crystal cell includes a first substrate, a second substrate, and a liquid crystal layer disposed between the first substrate and the second substrate.

### Embodiment 2

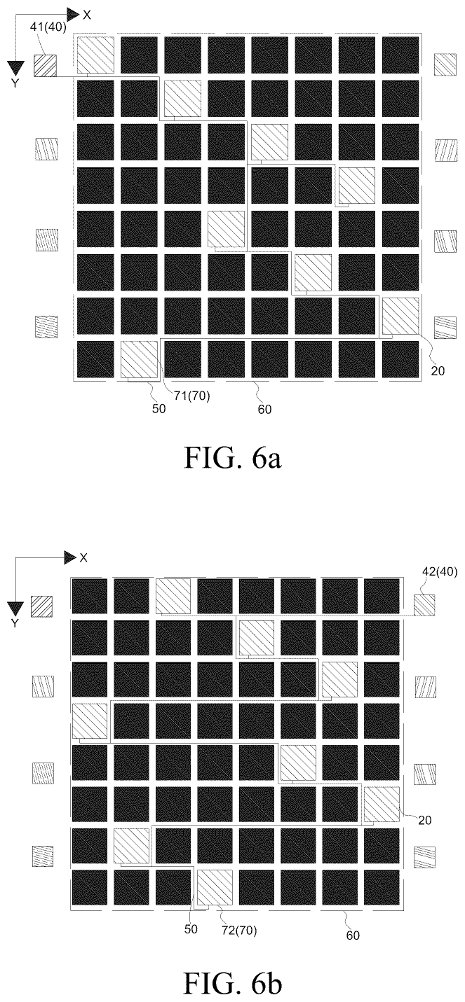

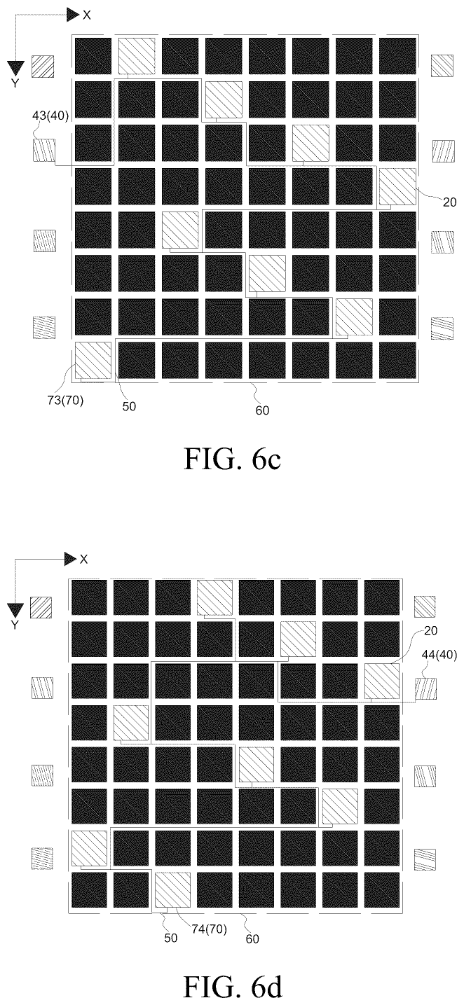

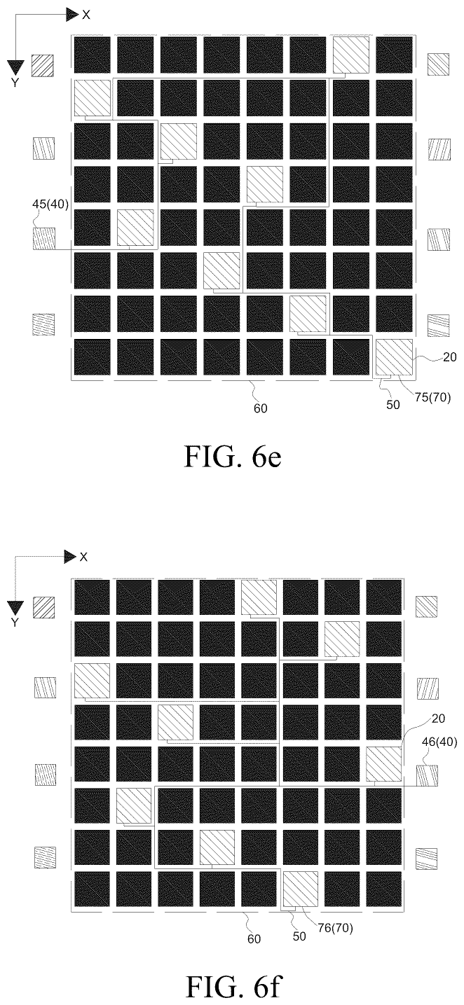

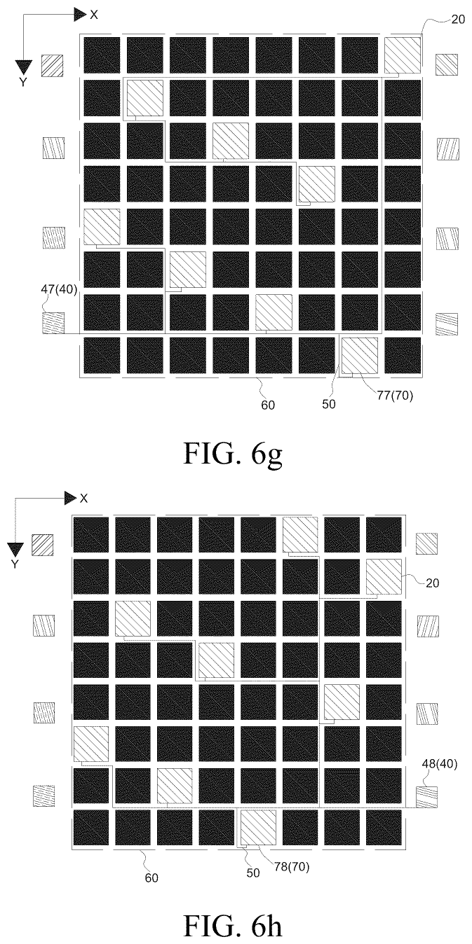

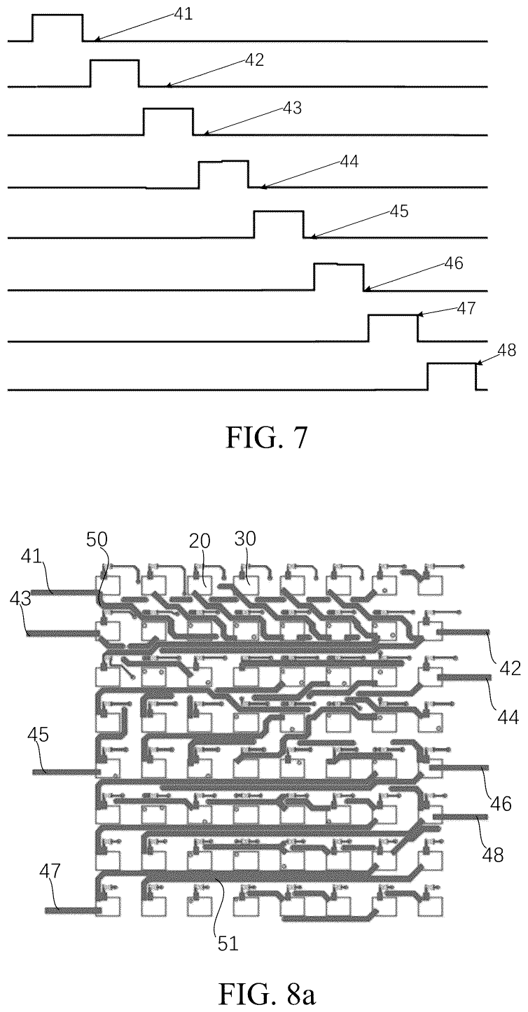

FIG. 6a is a schematic plan view showing that light-emitting units in each brightness subarea in a first brightness subarea group corresponding to a first scanning electrode provided in Embodiment 2 of the present disclosure are in an active state, FIG. 6b is a schematic plan view showing that light-emitting units in each brightness subarea in a second brightness subarea group corresponding to a second scanning electrode provided in Embodiment 2 of the present disclosure are in an active state, FIG. 6c is a schematic plan view showing that light-emitting units in each brightness subarea in a third brightness subarea group corresponding to a third scanning electrode provided in Embodiment 2 of the present disclosure are in an active state, FIG. 6d is a schematic plan view showing that light-emitting units in each brightness subarea in a fourth brightness subarea group corresponding to a fourth scanning electrode provided in Embodiment 2 of the present disclosure are in an active state, FIG. 6e is a schematic plan view showing that light-emitting units in each brightness subarea in a fifth brightness subarea group corresponding to a fifth scanning electrode provided in Embodiment 2 of the present disclosure are in an active state, FIG. 6f is a schematic plan view showing that light-emitting units in each brightness subarea in a sixth brightness subarea group corresponding to a sixth scanning electrode provided in Embodiment 2 of the present disclosure are in an active state, FIG. 6g is a schematic plan view showing that light-emitting units in each brightness subarea in a seventh brightness subarea group corresponding to a seventh scanning electrode provided in Embodiment 2 of the present disclosure are in an active state, FIG. 6h is a schematic plan view showing that light-emitting units in each brightness subarea in an eighth brightness subarea group corresponding to an eighth scanning electrode provided in Embodiment 2 of the present disclosure are in an active state, and FIG. 7 is a timing diagram of signals applied on the first scanning electrode to the eighth scanning electrode provided in Embodiment 2 of the present disclosure.

As illustrated in FIG. 1, FIG. 6a, FIG. 6b, FIG. 6c, FIG. 6d, FIG. 6e, FIG. 6f, FIG. 6g, FIG. 6h, and FIG. 7, in a first aspect, Embodiment 2 of the present disclosure provides a light board 10. The light board 10 includes a plurality of light-emitting units 30. The light board 10 has a plurality of brightness subareas 20. Each of the brightness subareas 20 is provided with a fixed number of light-emitting units 30. The plurality of brightness subareas 20 include multiple brightness subareas 20 arranged sequentially in a first direction X and multiple brightness subareas 20 arranged sequentially in a second direction Y, and the first direction X and the second direction Y intersect. In two adjacent brightness subareas 20 in the first direction X, the light-emitting units 30 in one brightness subarea 20 and the light-emitting units 30 in the other brightness subarea 20 do not light up simultaneously. In two adjacent brightness subareas 20 in the second direction Y, the light-emitting units 30 in one brightness subarea 20 and the light-emitting units 30 in the other brightness subarea 20 do not light up simultaneously.

It should be noted that a structure of the light board 10 provided in Embodiment 2 of the present disclosure is similar to a structure of the light board 10 provided in Embodiment 1 of the present disclosure. The same parts will not be described again in Embodiment 2 of the present disclosure.

In some embodiments of the present disclosure, the light board 10 includes one brightness subarea block 60, and the brightness subarea block 60 includes more than three brightness subarea groups 70. That is, m=1, n is an integer greater than 2. The scanning electrode 40 corresponding to each brightness subarea group 70 is electrically connected to one brightness subarea 20 in each row of the brightness subareas 20, and the scanning electrode 40 corresponding to each brightness subarea group 70 is electrically connected to one brightness subarea 20 in each column of the brightness subareas 20.

In the light board 10 provided in the embodiment of the present disclosure, since the brightness subarea block 60 includes more than three brightness subarea groups 70, correspondingly, the number of scanning electrodes 40 corresponding to the brightness subarea block 60 is also more than three. That is, the present disclosure may divide the plurality of brightness subareas 20 in the brightness subarea block 60 into more detailed groups to reduce the number of brightness subareas 20 corresponding to one scanning electrode 40, so as to reduce the driving load of the scanning electrode 40 and extend the service life of the light board 10.

Continuing to refer to FIG. 6a to FIG. 6h, in some embodiments of the present disclosure, the brightness subarea block 60 of the light board 10 includes 8 rows and 8 columns i.e. a total of 64 brightness subareas 20. The brightness subarea block 60 includes a first brightness subarea group 71, a second brightness subarea group 72, a third brightness subarea group 73, a fourth brightness subarea group 74, a fifth brightness subarea group 75, a sixth brightness subarea group 76, a seventh brightness subarea group 77, and an eighth brightness subarea groups 78. The first brightness subarea group 71 includes the brightness subareas 20 in Row 1 Column 1, Row 2 Column 3, Row 3 Column 5, Row 4 Column 7, Row 5 Column 4, Row 6 Column 6, Row 7 Column 8, and Row 8 Column 2. The second brightness subarea group 72 includes the brightness subareas 20 in Row 1 Column 3, Row 2 Column 5, Row 3 Column 7, Row 4 Column 1, Row 5 Column 6, Row 6 Column 8, Row 7 Column 2, and Row 8 Column 4. The third brightness subarea group 73 includes the brightness subareas 20 in Row 1 Column 2, Row 2 Column 4, Row 3 Column 6, Row 4 Column 8, Row 5 Column 3, Row 6 Column 5, Row 7 Column 7, and Row 8 Column 1. The fourth brightness subarea group 74 includes the brightness subareas 20 in Row 1 Column 4, Row 2 Column 6, Row 3 Column 8, Row 4 Column 2, Row 5 Column 5, Row 6 Column 7, Row 7 Column 1, and Row 8 Column 3. The fifth brightness subarea group 75 includes the brightness subareas 20 in Row 1 Column 7, Row 2 Column 1, Row 3 Column 3, Row 4 Column 5, Row 5 Column 2, Row 6 Column 4, Row 7 Column 6, and Row 8 Column 8. The sixth brightness subarea group 76 includes the brightness subareas 20 in Row 1 Column 5, Row 2 Column 7, Row 3 Column 1, Row 4 Column 3, Row 5 Column 8, Row 6 Column 2, Row 7 Column 4, and Row 8 Column 6. The seventh brightness subarea group 77 includes the brightness subareas 20 in Row 1 Column 8, Row 2 Column 2, Row 3 Column 4, Row 4 Column 6, Row 5 Column 1, Row 6 Column 3, Row 7 Column 5, and Row 8 Column 7. The eighth brightness subarea group 78 includes the brightness subareas 20 in Row 1 Column 6, Row 2 Column 8, Row 3 Column 2, Row 4 Column 4, Row 5 Column 7, Row 6 Column 1, Row 7 Column 3, and Row 8 Column 5.

Continuing to refer to FIG. 6a to FIG. 6h, the scanning electrodes 40 of the light board 10 include a first scanning electrode 41, a second scanning electrode 42, a third scanning electrode 43, a fourth scanning electrode 44, a fifth scanning electrode 45, and a sixth scanning electrodes 46, a seventh scanning electrode 47, and an eighth scanning electrode 48. The first scanning electrode 41 is electrically connected to the light-emitting units 30 in the eight brightness subareas 20 in the first brightness subarea group 71. The second scanning electrode 42 is electrically connected to the light-emitting units 30 in the eight brightness subareas 20 in the second brightness subarea group 72. The third scanning electrode 43 is electrically connected to the light-emitting units 30 in the eight brightness subareas 20 in the third brightness subarea group 73. The fourth scanning electrode 44 is electrically connected to the light-emitting units 30 in the eight brightness subareas 20 in the fourth brightness subarea group 74. The fifth scanning electrode 45 is electrically connected to the light-emitting units 30 in the eight brightness subareas 20 in the fifth brightness subarea group 75. The sixth scanning electrode 46 is electrically connected to the light-emitting units 30 in the eight brightness subareas 20 in the sixth brightness subarea group 76. The seventh scanning electrode 47 is electrically connected to the light-emitting units 30 in the eight brightness subareas 20 in the seventh brightness subarea group 77. The eighth scanning electrode 48 is electrically connected to the light-emitting units 30 in the eight brightness subareas 20 in the eighth brightness subarea group 78.

Continuing to refer to FIG. 7, in some embodiments of the present disclosure, during one phase period, the light-emitting units 30 in all brightness subareas 20 on the light board 10 are lit once. One phase period includes one cycle, and during the cycle, the driving signals of the first scanning electrode 41, the second scanning electrode 42, the third scanning electrode 43, the fourth scanning electrode 44, the fifth scanning electrode 45, the sixth scanning electrode 46, the seventh scanning electrode 47, and the eighth scanning electrode 48 are sequentially transmitted to the light-emitting units 30 in each brightness subarea 20 in the corresponding first brightness subarea group 71, the light-emitting units 30 in each brightness subarea 20 in the corresponding second brightness subarea group 72, the light-emitting units 30 in each brightness subarea 20 in the corresponding third first brightness subarea group 73, the light-emitting units 30 in each brightness subarea 20 in the corresponding fourth brightness subarea group 74, the light-emitting units 30 in each brightness subarea 20 in the corresponding fifth brightness subarea group 75, the light-emitting units 30 in each brightness subarea 20 in the corresponding sixth brightness subarea group 76, the light-emitting units 30 in each brightness subarea 20 in the corresponding seventh brightness subarea group 77, and the light-emitting units 30 in each brightness subarea 20 in the corresponding eighth brightness subarea group 78. The first scanning electrode 41, the second scanning electrode 42, the third scanning electrode 43, the fourth scanning electrode 44, the fifth scanning electrode 45, the sixth scanning electrode 46, the seventh scanning electrode 47, and the eighth scanning electrode 48 are scanned sequentially. This scanning method can enable that the light-emitting unit 30 in each brightness subarea 20 in the first brightness subarea group 71, the light-emitting units 30 in each brightness subarea 20 in the second brightness subarea group 72, the light-emitting units 30 in each brightness subarea 20 in the third brightness subarea group 73, the light-emitting units 30 in each brightness subarea 20 in the fourth brightness subarea group 74, the light-emitting units 30 in each brightness subarea 20 in the fifth brightness subarea group 75, the light-emitting unit 30 in each brightness subarea 20 in the sixth brightness subarea group 76, the light-emitting units 30 in each brightness subarea 20 in the seventh brightness subarea group 77, and the light-emitting units 30 in each brightness subarea 20 in the eighth brightness subarea group 78 are lit sequentially, thereby achieving that in the two adjacent brightness subareas 20 in the first direction X, the light-emitting units 30 in one brightness subarea 20 and the light-emitting units 30 in the other brightness subarea 20 do not light up at the same time, and in the two adjacent brightness subareas 20 in the second direction Y, the light-emitting units 30 in one brightness subarea 20 and the light-emitting units 30 in the other brightness subarea 20 do not light up at the same time.

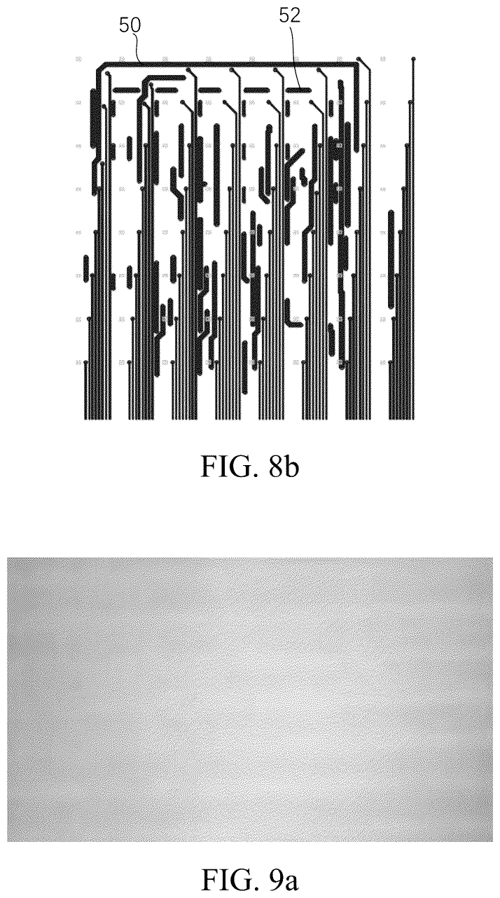

FIG. 8a is a schematic plan view of scanning electrodes and first portions of scanning lines provided in Embodiment 2 of the present disclosure, and FIG. 8b is a schematic plan view of second portions of the scanning lines provided in Embodiment 2 of the present disclosure. Referring to FIG. 8a and FIG. 8b, the scanning electrodes 40 are connected to the light-emitting units 30 in the brightness subareas 20 through the scanning lines 50. Each of the plurality of scanning lines 50 includes a first portion 51 and a second portion. part 52, the first portion 51 and the scanning electrode 40 are arranged in the same layer, and the second portion 52 and the scanning line 50 are arranged in a different layer.

In the light board 10 provided by the present disclosure, when the scanning line 50 corresponding to one scanning electrode 40 and the scanning line 50 corresponding to another scanning electrode 40 cross in the first direction X or the second direction Y, the two scanning lines 50 with different extension directions may interfere, increasing the difficulty of wiring design. In the present disclosure, each of the plurality of scanning lines 50 includes the first portion 51 and the second portion 52, the first portion 51 is arranged in the same layer as the scanning electrode 40, and the second portion 52 is arranged in a different layer from the scanning line 50, which may reduce a number of film layers as much as possible while improving the interference problem between two scanning lines 50 with different extension directions through the double-layer design, thereby reducing the wiring difficulty of the scanning lines 50 on the light board 10.

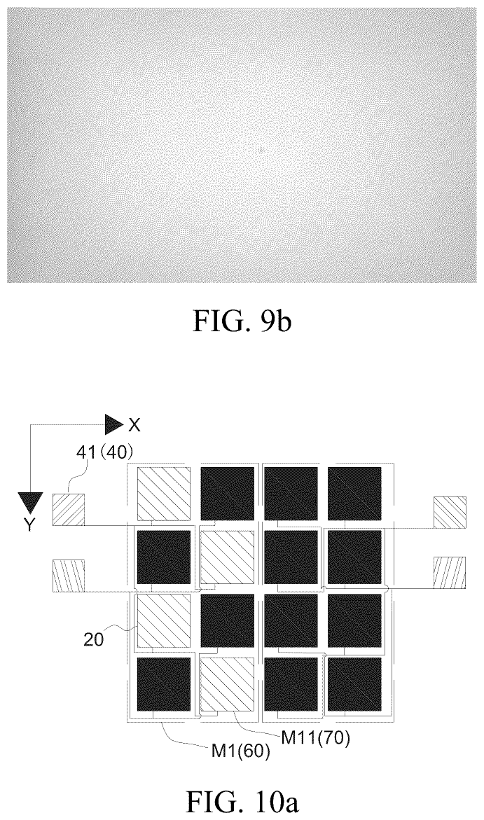

FIG. 9a is a schematic diagram of light distribution of a light board in related art, and FIG. 9b is a schematic diagram of light distribution of a light board provided by the present disclosure. Referring to FIG. 9a and FIG. 9b, when a total lighting time of the light board 10 is the same, the light board 10 provided by the present disclosure has a better light distribution state and a better optical effect.

In a second aspect, the embodiment of the present disclosure further provides a display panel, which includes the light board 10 described in any one of the above. Optionally, the display panel includes the light board 10 and a liquid crystal cell. The liquid crystal cell includes a first substrate, a second substrate, and a liquid crystal layer disposed between the first substrate and the second substrate.

### Embodiment 3

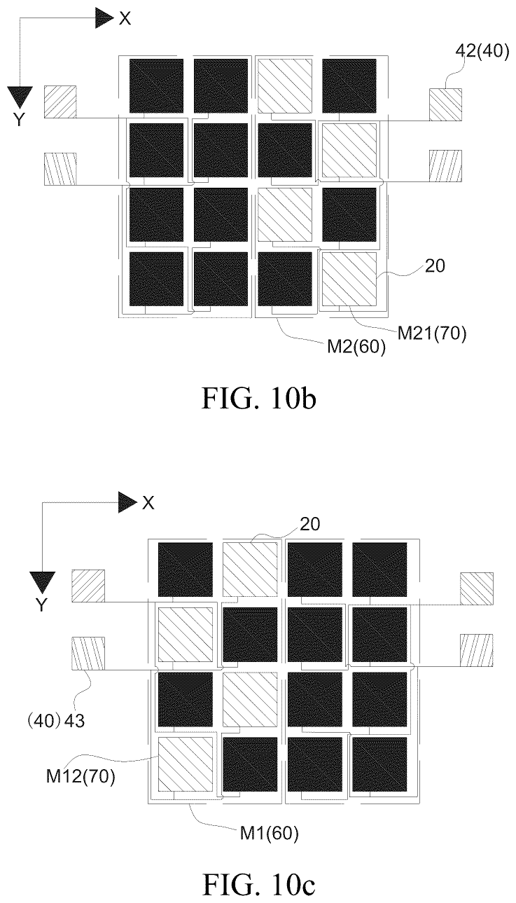

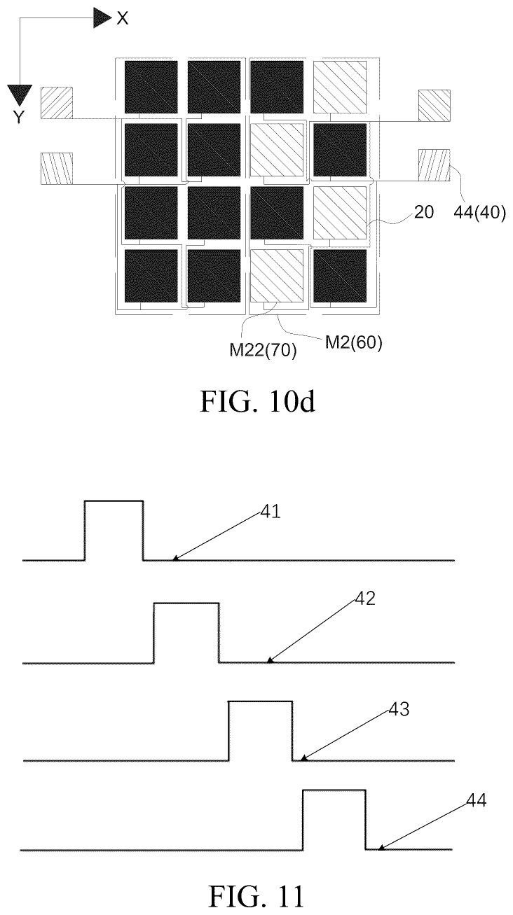

FIG. 10a is a schematic plan view showing that light-emitting units in each brightness subarea in a 1^{st} brightness subarea group in a 1^{st} brightness subarea block corresponding to a first scanning electrode provided in Embodiment 3 of the present disclosure are in an active state, FIG. 10b is a schematic plan view showing that light-emitting units in each brightness subarea in a 1^{st} brightness subarea group in a 2^{nd} brightness subarea block corresponding to a second scanning electrode provided in Embodiment 3 of the present disclosure are in an active state, FIG. 10c is a schematic plan view showing that light-emitting units in each brightness subarea in a 2^{nd} brightness subarea group in a 1^{st} brightness subarea block corresponding to a third scanning electrode provided in Embodiment 3 of the present disclosure are in an active state, FIG. 10d is a schematic plan view showing that light-emitting units in each brightness subarea in a 2^{nd} brightness subarea group in a 2^{nd} brightness subarea block corresponding to a fourth scanning electrode provided in Embodiment 3 of the present disclosure are in an active state, and FIG. 11 is a timing diagram of signals applied on the first scanning electrode to the fourth scanning electrode provided in Embodiment 3 of the present disclosure.

Referring to FIG. 1, FIG. 10a, FIG. 10b, FIG. 10c, FIG. 10d, and FIG. 11, in a first aspect, Embodiment 1 of the present disclosure provides a light board 10. The light board 10 includes a plurality of light-emitting units 30, and the light board 10 has a plurality of brightness subareas 20. Each brightness subarea 20 is provided with a fixed number of the light-emitting units 30. The plurality of brightness subareas 20 include multiple brightness subareas 20 arranged sequentially in a first direction X and multiple brightness subareas 20 arranged sequentially in a second direction Y, and the first direction X and the second direction Y intersect. In two adjacent brightness subareas 20 in the first direction X, the light-emitting units 30 in one brightness subarea 20 and the light-emitting units 30 in the other brightness subarea 20 do not light up simultaneously. In two adjacent brightness subareas 20 in the second direction Y, the light-emitting units 30 in one brightness subarea 20 and the light-emitting units 30 in the other brightness subarea 20 do not light up simultaneously.

It should be noted that a structure of the light board 10 provided in Embodiment 3 of the present disclosure is similar to the structure of the light board 10 provided in Embodiment 1 of the present disclosure. The same parts will not be described again in Embodiment 3 of the present disclosure.

In some embodiments of the present disclosure, the light board 10 includes m brightness subarea blocks 60, where m≥1 and m is an integer. Each of the brightness subarea blocks 60 includes n brightness subarea groups 70, where n≥2 and n is an integer. Each of the brightness subarea groups 70 includes at least one brightness subarea group 20. The light board 10 includes m×n scanning electrodes 40, and each scanning electrode 40 is electrically connected to the light-emitting units 30 in all brightness subareas 20 in one brightness subarea group 70. The two adjacent brightness subareas 20 in the first direction X respectively belong to two different brightness subarea groups 70, and the two adjacent brightness subareas 20 in the second direction Y respectively belong to two different brightness subarea groups 70. One of the first direction X and the second direction Y is a row direction, and the other of the first direction X and the second direction Y is a column direction. m is an integer greater than 1. That is, in the light board 10 provided in the embodiment of the present disclosure, the light board 10 includes a plurality of brightness subarea blocks 60 to reduce process difficulty and improve production yield.

In some embodiments of the present disclosure, m is an integer greater than 1, and one phase period includes n cycles. During an n-th cycle, each brightness subarea 20 in an n-th brightness subarea group 70 in a 1^{st} brightness subarea block M1 to each brightness subarea 20 in an n-th brightness subarea group 70 in an m-th brightness subarea block 60 are lit in sequence.

In the light board 10 provided by the present disclosure, during the n-th cycle, each brightness subarea 20 in the n-th brightness subarea group 70 in the 1^{st} brightness subarea block M1 to each brightness subarea 20 in the n-th brightness subarea group 70 in the m-th brightness subarea block 60 are lit in sequence, so the problem of declined optical effect of the light board 10 caused by the arrangement of multiple brightness subarea groups 70 may be avoided as much as possible.

Continuing to refer to FIG. 10a, FIG. 10b, FIG. 10c, FIG. 10d, and FIG. 11, in some embodiments of the present disclosure, m=2, n=2. The light board 10 includes a 1^{st} brightness subarea block M1 and a 2^{nd} brightness subarea block M2 arranged axially symmetrically. The brightness subareas 20 in odd rows and odd columns and the brightness subarea blocks 60 in even rows and even columns in the 1^{st} brightness subarea block M1 consist a 1^{st} brightness subarea group M11 in the 1^{st} brightness subarea block M1. The brightness subareas 20 in even rows and odd columns and the brightness subarea blocks 60 in odd rows and even columns in the 1^{st} brightness subarea block M1 consist a 2^{nd} brightness subarea group M12 in the 1^{st} brightness subarea block M1. The brightness subareas 20 in odd rows and odd columns and the brightness subarea blocks 60 in even rows and even columns in the 2^{nd} brightness subarea block M2 consist a 1^{st} brightness subarea group M21 in the 2^{nd} brightness subarea block M2. The brightness subareas 20 in even rows and odd columns and the brightness subarea blocks 60 in odd rows and even columns in the 2^{nd} brightness subarea block M2 consist a 2^{nd} brightness subarea group 70 in the 2^{nd} brightness subarea block M2. One phase period includes 2 cycles, and during a 1^{st} cycle, the light-emitting units 30 in each brightness subarea 20 in the 1^{st} brightness subarea group M11 in the 1^{st} brightness subarea block M1 and the light-emitting units 30 in each brightness subarea 20 in the 1^{st} brightness subarea group M21 in the 2^{nd} brightness subarea block M2 are lit in sequence. And then during a 2^{nd} cycle, the light-emitting units 30 in each brightness subarea 20 in the 2^{nd} brightness subarea group M12 in the 1^{st} brightness subarea block M1 and the light-emitting units 30 in each brightness subarea 20 in the 2^{nd} brightness subarea group M22 in the 2^{nd} brightness subarea block M2 are lit in sequence. Of course, in other embodiments of the present disclosure, m may also be 3, 4, 5, 6, etc.; and n may also be 3, 4, 5, 6, 7, 8, etc.

Continuing to refer to FIG. 10a, FIG. 10b, FIG. 10c, FIG. 10d, and FIG. 11, in some embodiments of the present disclosure, the light board 10 includes a plurality of scanning electrodes 40, and the plurality of scanning electrodes 40 include a first scanning electrode 41, a second scanning electrode 42, a third scanning electrode 43, and a fourth scanning electrode 44. The first scanning electrode 41 is electrically connected to the light-emitting units 30 in each brightness subarea 20 in the 1^{st} brightness subarea group M11 in the 1^{st} brightness subarea block M1. The second scanning electrode 42 is electrically connected to the light-emitting units 30 in each brightness subarea 20 in the 1^{st} brightness subarea group M21 in the 2^{nd} brightness subarea block M2. The third scanning electrode 43 is electrically connected to the light-emitting units 30 in each brightness subarea 20 in the 2^{nd} brightness subarea group M12 in the 1^{st} brightness subarea block M1. The fourth scanning electrode 44 is electrically connected to the light-emitting units 30 in each brightness subarea 20 in the 2^{nd} brightness subarea group M22 in the 2^{nd} brightness subarea block M2.

In a second aspect, embodiments of the present disclosure further provide a display panel, which includes the light board 10 described in any one of the above. Optionally, the display panel includes the light board 10 and a liquid crystal cell. The liquid crystal cell includes a first substrate, a second substrate, and a liquid crystal layer disposed between the first substrate and the second substrate.

### Embodiment 4

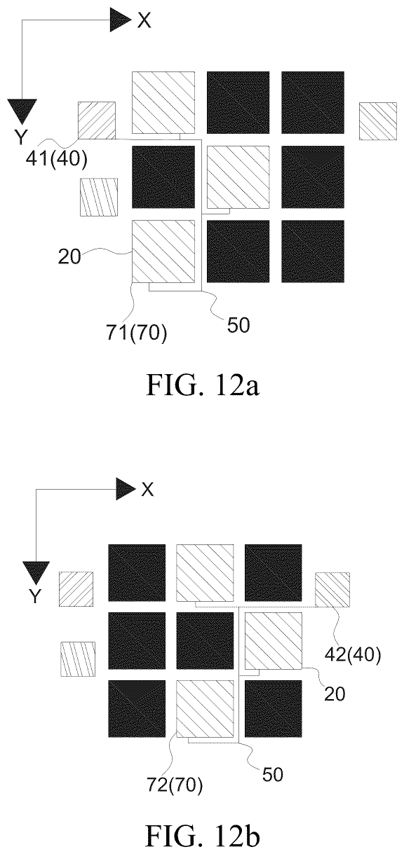

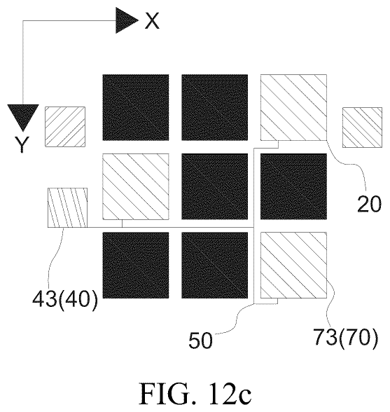

FIG. 12a is a schematic plan view showing that light-emitting units in each brightness subarea in a first brightness subarea group corresponding to a first scanning electrode of a light board provided in Embodiment 4 of the present disclosure are in an active state, FIG. 12b is a schematic plan view showing that light-emitting units in each brightness subarea in a second brightness subarea group corresponding to a second scanning electrode provided of a light board provided in Embodiment 4 of the present disclosure are in an active state, and FIG. 12c is a schematic plan view showing that light-emitting units in each brightness subarea in a third brightness subarea group corresponding to a third scanning electrode of a light board provided in Embodiment 4 of the present disclosure are in an active state.

As illustrated in FIG. 1, FIG. 12a, FIG. 12b, and FIG. 12c, in a first aspect, Embodiment 1 of the present disclosure provides a light board 10. The light board 10 includes a plurality of light-emitting units 30, and the light board 10 has a plurality of brightness subareas 20. Each brightness subarea 20 is provided with a fixed number of the light-emitting units 30. The plurality of brightness subareas 20 include multiple brightness subareas 20 arranged sequentially in a first direction X and multiple brightness subareas 20 arranged sequentially in a second direction Y, and the first direction X and the second direction Y intersect. In two adjacent brightness subareas 20 in the first direction X, the light-emitting units 30 in one brightness subarea 20 and the light-emitting units 30 in the other brightness subarea 20 do not light up simultaneously. In two adjacent brightness subareas 20 in the second direction Y, the light-emitting units 30 in one brightness subarea 20 and the light-emitting units 30 in the other brightness subarea 20 do not light up simultaneously.

It should be noted that a structure of the light board 10 provided in Embodiment 4 of the present disclosure is similar to the structure of the light board 10 provided in Embodiment 1 of the present disclosure. The same parts will not be described again in Embodiment 4 of the present disclosure.

In some embodiments of the present disclosure, each brightness subarea block 60 includes three brightness subarea groups 70, and each brightness subarea group 70 includes three brightness subareas 20. Nine brightness subarea blocks 60 corresponding to the three brightness subarea groups 70 define a nine-square grid structure. Two brightness subareas 20 in each of the brightness subarea groups 70 are arranged in the same row, or two brightness subareas 20 in each of the brightness subarea groups 70 are arranged in the same column.

In the light board 10 provided by the present disclosure, when the number of the brightness subareas 20 is an odd number, the present disclosure can ensure a condition that the two adjacent brightness subareas 20 in the first direction X respectively belong to two different brightness subarea groups 70, and the two adjacent brightness subareas 20 in the second direction Y respectively belong to two different brightness subarea groups 70, and based on this condition, by adjusting the number of the scanning electrodes 40 and a distribution state of the brightness subarea blocks 60, each scanning electrode 40 still corresponds to the same number of brightness subareas 20, thereby ensuring the optical effect of the light board 10.

Referring to FIG. 12a, FIG. 12b, and FIG. 12c, the first brightness subarea group 71 includes the brightness subareas 20 in Row 1 Column 1, Row 2 Column 2, and Row 3 Column 1; the second brightness subarea group 72 includes the brightness subareas 20 in Row 1 Column 2, Row 2 Column 3, and Row 3 Column 2; and the third brightness subarea group 73 includes the brightness subareas 20 in Row 1 Column 3, Row 2 Column 1, and Row 3 Column 2. The first scanning electrode 41 is electrically connected to the light-emitting units 30 in the three brightness subareas 20 in the first brightness subarea group 71, the second scanning electrode 42 is electrically connected to the light-emitting units 30 in the three brightness subareas 20 in the second brightness subarea group 72, and the third scanning electrode 43 is electrically connected to the light-emitting units 30 in the three brightness subareas 20 in the third brightness subarea group 73.

It should be noted that FIG. 12a, FIG. 12b, and FIG. 12c respectively illustrate that the two brightness subareas 20 in the first brightness subarea group 71 are arranged in the same column, the two brightness subareas 20 in the second brightness subarea group 72 are arranged in the same column, and the two brightness subareas 20 in the third brightness subarea group 73 are arranged in the same column. In other embodiments of the present disclosure, the two brightness subareas 20 in the first brightness subarea group 71 may be arranged in the same row, the two brightness subareas 20 in the second brightness subarea group 72 may be arranged in the same row, and the two brightness subareas 20 in the third brightness subarea group 73 may be arranged in the same row. The arrangement principle is similar to that illustrated in FIG. 12a, FIG. 12b, and FIG. 12c, which will not be described again in the present disclosure.

In a second aspect, the embodiment of the present disclosure further provides a display panel, which includes the light board 10 described in any one of the above. Optionally, the display panel includes the light board 10 and a liquid crystal cell. The liquid crystal cell includes a first substrate, a second substrate, and a liquid crystal layer disposed between the first substrate and the second substrate.

In summary, the present disclosure provides light boards and display panels. The light board includes the plurality of light-emitting units. The light board has the plurality of brightness subareas. A fixed number of light-emitting units are provided in each brightness subarea. The plurality of brightness subareas include multiple brightness subareas arranged sequentially in a first direction and multiple brightness subareas arranged sequentially in a second direction, and the first direction and the second direction intersect. In two adjacent brightness subareas in the first direction, the light-emitting units in one brightness subarea and the light-emitting units in the other brightness subarea do not light up simultaneously. In two adjacent brightness subareas in the second direction, the light-emitting units in one brightness subarea and the light-emitting units in the other brightness subarea do not light up simultaneously. In the light board and display panel provided by the present disclosure, in the two adjacent brightness subareas in the first direction, the light-emitting units in one brightness subarea and the light-emitting units in the other brightness subarea do not light up at the same time; and in the two adjacent brightness subareas in the second direction, the light-emitting unit in one brightness subarea and the light-emitting units in the other brightness subarea do not light up at the same time. Therefore, during actual operation of the light board, staggered lighting of the light-emitting units in the plurality of brightness subareas may be achieved. On the one hand, it may improve the problem of instantaneous local energy concentration of the light board in the PWM driving mode, inhibiting the possibility of short-term failure. On the other hand, it may effectively reduce the probability of rule failure in a long-term lighting state of the light board. Furthermore, the optical effect of the light board and the optical effect of the display panel applying the light board are improved, and the life of the light board and the life of the display panel applying the light board are extended.

The above is a detailed introduction to the light boards and the display panels provided by the embodiments of the present disclosure. Specific examples are used in this paper to illustrate the principles and implementation methods of the present disclosure. The description of the above embodiments is only used to help understand methods and core ideas of the present disclosure. At the same time, for those skilled in the art, there will be changes in the specific implementation and application scope based on the ideas of the present disclosure. In summary, the content of this description should not be understood as a limitation of the present disclosure.

1. A light board, having a plurality of brightness subareas, wherein each of the brightness subareas is provided with a fixed number of light-emitting units, the plurality of brightness subareas comprise multiple brightness subareas arranged sequentially in a first direction and multiple brightness subareas arranged sequentially in a second direction, and the first direction and the second direction intersect;
in two adjacent brightness subareas of the plurality of brightness subareas in the first direction, the light-emitting units in one of the two adjacent brightness subareas and the light-emitting units in the other one of the two adjacent brightness subareas light up at different times; and
in two adjacent brightness subareas of the plurality of brightness subareas in the second direction, the light-emitting units in one of the two adjacent brightness subareas and the light-emitting units in the other one of the two adjacent brightness subareas light up at different times.

2. The light board according to claim 1, comprising a plurality of scanning electrodes electrically connected to the light-emitting units and configured to control active states of the light-emitting units,
wherein in the two adjacent brightness subareas in the first direction, one of the scanning electrodes connected to the light-emitting units in one of the two adjacent brightness subareas is different from another one of the scanning electrodes connected to the light-emitting units the other one of the two adjacent brightness subareas;
in the two adjacent brightness subareas in the second direction, one of the scanning electrodes connected to the light-emitting units in one of the two adjacent brightness subareas is different from another one of the scanning electrodes connected to the light-emitting units the other one of the two adjacent brightness subareas; and
timings of driving signals of the scanning electrodes corresponding to the two adjacent brightness subareas in the first direction are different, and timings of driving signals of the scanning electrodes corresponding to the two adjacent brightness subareas in the second direction are different.

3. The light board according to claim 2, wherein a number of the scanning electrodes is a, a number of the brightness subareas is b, and each of the scanning electrodes is electrically connected to the light-emitting units in b/a ones of the brightness subareas, where b≥a≥2 and b/a is an integer.

4. The light board according to claim 2,
wherein the light board comprises m brightness subarea blocks, where m≥1 and m is an integer; each of the brightness subarea blocks comprises n brightness subarea groups, where n≥2 and n is an integer; and each of the brightness subarea groups comprises at least one brightness subarea; and
the light board comprises m×n scanning electrodes, and each of the scanning electrodes is electrically connected to the light-emitting units in all of the brightness subareas in one of the brightness subarea groups.

5. The light board according to claim 4, wherein each of the brightness subarea blocks comprises a plurality rows of the brightness subareas and a plurality columns of the brightness subareas; and
in each of the brightness subarea blocks, each of the scanning electrodes corresponding to one of the brightness subarea groups is electrically connected to the light-emitting units in at least one brightness subarea in each row of the brightness subareas.

6. The light board according to claim 5, wherein in each of the brightness subarea blocks, each of the scanning electrodes corresponding to one of the brightness subarea groups is electrically connected to the light-emitting units in at least one brightness subarea in each column of the brightness subareas.

7. The light board according to claim 6, wherein m=1 and n=2, one of the scanning electrodes corresponding to one of the brightness subarea groups is electrically connected to the light-emitting units in the brightness subareas in odd rows and odd columns and the light-emitting units in the brightness subareas in even rows and columns, and one of the scanning electrodes corresponding to the other one of the brightness subarea groups is electrically connected to the light-emitting units in the brightness subareas in even rows and odd columns and the light-emitting units in the brightness subareas in odd rows and even columns.

8. The light board according to claim 6, wherein m=1 and n is an integer greater than 2, each of the scanning electrodes corresponding to one of the brightness subarea groups is electrically connected to the light-emitting units in one brightness subarea in each row of the brightness subareas, and each of the scanning electrodes corresponding to one of the brightness subarea groups is electrically connected to the light-emitting units in one brightness subarea in each column of the brightness subareas.

9. The light board according to claim 4, wherein m is an integer greater than 1, one phase period comprises n cycles, during an n-th cycle, each of the brightness subareas in an n-th brightness subarea group in a 1^{st} brightness subarea block to each of the brightness subarea in an n-th brightness subarea group in an m-th brightness subarea block are lit in sequence.

10. The light board according to claim 9, wherein m=2 and n=2, the light board comprises the 1^{st} brightness subarea block and a 2^{nd} brightness subarea block arranged axially symmetrically;
the brightness subareas in odd rows and odd columns and the brightness subarea blocks in even rows and even columns in the 1^{st} brightness subarea block consist a 1^{st} brightness subarea group in the 1^{st} brightness subarea block, and the brightness subareas in even rows and odd columns and the brightness subarea blocks in odd rows and even columns in the 1^{st} brightness subarea block consist a 2^{nd} brightness subarea group in the 1^{st} brightness subarea block;
the brightness subareas in odd rows and odd columns and the brightness subarea blocks in even rows and even columns in the 2^{nd} brightness subarea block consist a 1^{st} brightness subarea group in the 2^{nd} brightness subarea block, and the brightness subareas in even rows and odd columns and the brightness subarea blocks in odd rows and even columns in the 2^{nd} brightness subarea block consist a 2^{nd} brightness subarea group in the 2^{nd} brightness subarea block;
one phase period comprises 2 cycles;
during a 1^{st} cycle, the light-emitting units in each of the brightness subareas in the 1^{st} brightness subarea group in the 1^{st} brightness subarea block and the the light-emitting units in each of the brightness subareas in the 1^{st} brightness subarea group in the 2^{nd} brightness subarea block are lit in sequence; and
during a 2^{nd} cycle, the light-emitting units in each of the brightness subareas in the 2^{nd} brightness subarea group in the 1^{st} brightness subarea block and the light-emitting units in each of the brightness subareas in the 2^{nd} brightness subarea group in the 2^{nd} brightness subarea block are lit in sequence.

11. The light board according to claim 4, wherein each of the brightness subarea blocks comprises three brightness subarea groups, each of the brightness subarea groups comprises three brightness subareas, and nine brightness subareas corresponding to the three brightness subarea groups define a nine-square grid structure, two of the brightness subareas in each of the brightness subarea groups are arranged in the same row, or two of the brightness subareas in each of the brightness subarea groups are arranged in the same column.

12. The light board according to claim 2, wherein the light board further comprises a plurality of scanning lines, the scanning electrodes are connected to the light-emitting units in the brightness subareas through the scanning lines, each of the plurality of scanning lines comprises a first portion and a second portion, the first portion is arranged in the same layer as the scanning electrodes, and the second portion is arranged in a different layer from the scanning electrodes.

13. A display panel, comprising a light board, the light board having a plurality of brightness subareas, wherein each of the brightness subareas is provided with a fixed number of light-emitting units, the plurality of brightness subareas comprise multiple brightness subareas arranged sequentially in a first direction and multiple brightness subareas arranged sequentially in a second direction, and the first direction and the second direction intersect;
in two adjacent brightness subareas of the plurality of brightness subareas in the first direction, the light-emitting units in one of the two adjacent brightness subareas and the light-emitting units in the other one of the two adjacent brightness subareas light up at different times; and
in two adjacent brightness subareas of the plurality of brightness subareas in the second direction, the light-emitting units in one of the two adjacent brightness subareas and the light-emitting units in the other one of the two adjacent brightness subareas light up at different times.

14. The display panel according to claim 13, wherein the light board comprises a plurality of scanning electrodes electrically connected to the light-emitting units and configured to control active states of the light-emitting units,
in the two adjacent brightness subareas in the first direction, one of the scanning electrodes connected to the light-emitting units in one of the two adjacent brightness subareas is different from another one of the scanning electrodes connected to the light-emitting units the other one of the two adjacent brightness subareas;
in the two adjacent brightness subareas in the second direction, one of the scanning electrodes connected to the light-emitting units in one of the two adjacent brightness subareas is different from another one of the scanning electrodes connected to the light-emitting units the other one of the two adjacent brightness subareas; and
timings of driving signals of the scanning electrodes corresponding to the two adjacent brightness subareas in the first direction are different, and timings of driving signals of the scanning electrodes corresponding to the two adjacent brightness subareas in the second direction are different.

15. The display panel according to claim 14, wherein a number of the scanning electrodes is a, a number of the brightness subareas is b, and each of the scanning electrodes is electrically connected to the light-emitting units in b/a ones of the brightness subareas, where b≥a≥2 and b/a is an integer.

16. The display panel according to claim 14, wherein the light board comprises m brightness subarea blocks, where m≥1 and m is an integer; each of the brightness subarea blocks comprises n brightness subarea groups, where n≥2 and n is an integer; and each of the brightness subarea groups comprises at least one brightness subarea; and
the light board comprises m×n scanning electrodes, and each of the scanning electrodes is electrically connected to the light-emitting units in all of the brightness subareas in one of the brightness subarea groups.

17. The display panel according to claim 16, wherein each of the brightness subarea blocks comprises a plurality rows of the brightness subareas and a plurality columns of the brightness subareas;
in each of the brightness subarea blocks, each of the scanning electrodes corresponding to one of the brightness subarea groups is electrically connected to the light-emitting units in at least one brightness subarea in each row of the brightness subareas; and
in each of the brightness subarea blocks, each of the scanning electrodes corresponding to one of the brightness subarea groups is electrically connected to the light-emitting units in at least one brightness subarea in each column of the brightness subareas.

18. The display panel according to claim 16, wherein m is an integer greater than 1, one phase period comprises n cycles, during an n-th cycle, each of the brightness subareas in an n-th brightness subarea group in a 1^{st} brightness subarea block to each of the brightness subarea in an n-th brightness subarea group in an m-th brightness subarea block are lit in sequence.

19. The display panel according to claim 16, wherein each of the brightness subarea blocks comprises three brightness subarea groups, each of the brightness subarea groups comprises three brightness subareas, and nine brightness subareas corresponding to the three brightness subarea groups define a nine-square grid structure, two of the brightness subareas in each of the brightness subarea groups are arranged in the same row, or two of the brightness subareas in each of the brightness subarea groups are arranged in the same column.

20. The display panel according to claim 14, wherein the light board further comprises a plurality of scanning lines, the scanning electrodes are connected to the light-emitting units in the brightness subareas through the scanning lines, each of the plurality of scanning lines comprises a first portion and a second portion, the first portion is arranged in the same layer as the scanning electrodes, and the second portion is arranged in a different layer from the scanning lines.
